(19) United States
(12) Patent Application Publication
(10) Pub. No.: US 2023/0381860 A1
(43) Pub. Date: Nov. 30, 2023

(54) METHOD FOR PRODUCING A HYBRID COMPONENT, AND CORRESPONDING HYBRID COMPONENT

(71) Applicant: Schunk Sintermetalltechnik GmbH (Thale), Thale (DE)

(72) Inventors: Thomas WAMSER, Heuchelheim (DE); Ingolf LANGER, Quedlinburg (DE); Jannis PAULSEN, Thale (DE); Frank BAUMGÄRTNER, Staufenberg (DE)

(73) Assignee: Schunk Sintermetalltechnik GmbH (Thale), Thale (DE)

(21) Appl. No.: 18/318,998

(22) Filed: May 17, 2023

(30) Foreign Application Priority Data
May 25, 2022 (EP) 22175520.0

(51) Int. Cl. B22F 7/08; B22F 3/16; B22F 3/22; B22F 10/10

(52) U.S. Cl. CPC B22F 7/08; B22F 3/16; B22F 3/225; B22F 10/10; B33Y 80/00

(57) ABSTRACT

A method for producing a hybrid component including providing a first component constituent made of a metallic first material, a second component constituent in the form of a sleeve made of an electrically insulating second material, and a third component constituent made of a metallic third material and having a recess; forming a complete component assembly by arranging the first component constituent in an inner volume of the second component constituent and arranging the second component constituent in the recess of the third component constituent; and sintering the complete component assembly by heating to a sintering temperature.

### FIELD

The present invention relates to a method for producing a hybrid component. The invention relates further to a hybrid component which may correspondingly be produced.

### BACKGROUND

For the widest variety of industrial or other applications, components are used which are to perform specific functionalities under specified boundary conditions. In addition to structural properties, materials for the components must also be chosen such that they satisfy the boundary conditions and the functionalities that are to be achieved. Since in many cases a component consisting of a single material cannot satisfactorily meet all the requirements, components may be provided in the form of so-called hybrid components, in which different component constituents consist of different materials.

In the following description, hybrid components are described predominantly using the example of an electrode or an electrode feedthrough as may be employed for an electrical catalytic converter preheater for an exhaust system of a motor vehicle, and the production thereof.

Such an electrode or electrode feedthrough may be provided to connect a heating device integrated in the exhaust system to an electrical energy source arranged outside the exhaust system, in order to be able to supply the heating device with electrical power. Powers in the kilowatt range, in some cases up to 10 kW, may have to be transmitted with the aid of the electrode. The electrode generally has to be guided through a wall of the exhaust system and must be electrically insulated with respect to the wall. In addition, the electrode must be able to withstand the extreme conditions that prevail in the exhaust system in respect of high temperatures (often in the range of 700-1100° C.), mechanical loads such as in particular vibrations, chemical loads, in particular due to aggressive gases, etc.

In order to be able to satisfy all these requirements with a hybrid component, each of its individual component constituents must be suitably configured structurally, functionally and in respect of the materials used therein. In addition, the individual component constituents must interact suitably with one another, in particular must be mechanically connected to one another in a suitable manner, in order to reliably be able to fulfil their purpose in a wide operating temperature range and/or in the case of rapid temperature changes, despite forces that are acting and/or chemical aggression.

However, in addition to electrodes or electrode feedthroughs, a large number of other hybrid components may be used for the widest variety of applications. For example, bearing shells for rapidly rotating electric motors may be formed with the aid of hybrid components, in order to be able to satisfy different requirements in respect of strength, weight, mass inertia, electrical properties or the like, optionally within a wide operating temperature range.

In the production of hybrid components, it should be ensured that the component constituents that are used cooperate with one another in a desired manner, and optionally within a wide temperature range, in the long term and reliably. For example, the component constituents should be connected together fixedly, or for conjoint rotation, preferably both at an ambient temperature of, for example, 20° C. and at a very high operating temperature of, for example, many hundred degrees Celsius, often even above 1000° C. In many cases, a force-based and/or positive connection between the component constituents may be desirable. In addition, electrical and/or thermal insulation between individual component constituents of the hybrid component may be required, which may be effected by means of interposed insulating component constituents or layers.

Conventionally, hybrid components have mostly been produced using techniques such as a mechanical pressing-in and/or a thermal shrinking of one component constituent into another component constituent.

In the case of pressing-in, a first component constituent having a recess is provided, and a second component constituent is pressed into the recess. A fit between the two component constituents should here be very exact. For example, a fit of H7/s6 is often used. Accordingly, the two component constituents must generally be machined very accurately prior to the pressing-in in order, for example, to allow an outside geometry of the second component constituent and an inside geometry of the recess in the first component constituent to be matched precisely to one another and in order to allow tolerances to be kept low. In addition, it is frequently necessary to subsequently machine the assembled hybrid component after the second component constituent has been pressed in. Since both component constituents generally have to be subjected to precise preliminary machining and to post-machining after pressing-in, the total outlay in terms of production for the hybrid component is often high. In addition, pressing-in is often suitable only for metallic component constituents, but may be difficult to impossible in the case of electrically insulating component constituents made, for example, of ceramic material.

In the case of the alternative production technique of thermal joining by shrinking, the first component constituent together with its recess may first be heated. It thereby expands, so that dimensions of the recess are temporarily increased. The second component constituent may then be introduced into the recess. After cooling of the first component constituent, a strong force-based connection, or in some cases even a positive connection, may occur between the two component constituents. However, in the case of this production technique too, similarly to pressing-in, the two component constituents must generally be machined very precisely beforehand. A precise fit of, for example, H7/s6 is often desirable here too. Subsequent machining of the finished hybrid component may be necessary in many cases. Accordingly, this production technique often also results in a high outlay in terms of production.

In addition, in the case of thermal shrinking, conventionally only the coefficient of thermal expansion of the material pairing of the component constituents to be connected may be used. In other words, a force-based connection between the two component constituents may be dependent upon the relative differences in the thermal expansion of the two component constituents. Accordingly, on later use of the hybrid component, a functionality of the hybrid component may be limited or may only be present sufficiently over a particular operating temperature range.

For example, excessive heating of one of the component constituents may lead to at least partial loosening of the force-based connection between mutually adjoining component constituents.

A further possible way of producing hybrid components has been described in DE 101 27 626 A1. In order to produce a constructed workpiece having two elements connected together by force-based and/or positive engagement, at least a first element is produced by an MIM process (metal injection molding)—that is to say by injection molding a blank in the form of a green part from a plastics material/metal powder mixture, subsequently expelling the plastics material to produce a brown part, and then sintering the brown part. Shrinkage that occurs during sintering is utilized to hold a further element in a recess in the first element by positive or force-based engagement.

However, as explained in greater detail below, it has hitherto been assumed that, in particular owing to the sintering used in the proposed method, the described production technique may be used only for the production of specific hybrid components, in particular for the production of hybrid components in which all the component constituents are metallic. However, such hybrid components may not satisfy specified boundary conditions and desired functionalities in all cases.

### SUMMARY

There may therefore be a need for an alternative method for producing a hybrid component, with which a hybrid component having specific physical or functional properties may be manufactured in a simple, reliable and/or inexpensive manner, and with which at least some of the deficiencies described at the beginning of conventional methods may be overcome. In particular, there may be a need, for example, for a method for producing a hybrid component such as, for example, an electrode or electrode feedthrough, in which one component constituent may ensure, for example, the transmission of high electrical powers and another component constituent may ensure, for example, mechanical connection to a housing, for example of an exhaust gas channel, wherein a further component constituent effects satisfactory electrical insulation between the other two component constituents. Furthermore, there may be a need for a hybrid component which may correspondingly be produced. In addition, there may be a need to provide a hybrid component which is able to provide the mentioned functional properties reliably within a wide operating temperature range and/or under harsh conditions with attacking forces, vibrations and/or gases.

Such needs may be met with the subject-matter of one of the independent claims. Advantageous embodiments are defined in the dependent claims and in the following description and are illustrated in the accompanying figures.

According to a first aspect of the present invention, a method for producing a hybrid component is described. The method comprises at least the following steps, preferably, but not necessarily, in the indicated order:
providing a first component constituent made of a metallic first material,
providing a second component constituent made of an electrically insulating second material, wherein the second component constituent is in the form of a sleeve which surrounds an inner volume which has an inner contour complementary to an outer contour of the first component constituent,
providing a third component constituent made of a metallic third material, wherein the third component constituent has a recess which has an inner contour complementary to an outer contour of the second component constituent,
forming a complete component assembly by arranging the first component constituent in the inner volume of the second component constituent and arranging the second component constituent in the recess of the third component constituent, and
sintering the complete component assembly by heating to a sintering temperature.

The first component constituent and/or the third component constituent is/are in the form of a powder blank having metal powder particles arranged adjoining one another, such that, when the sintering temperature is reached, the metal particles are sintered together and the component constituent in question thereby experiences a volume change that remains even after cooling to below the sintering temperature, such that the outer contour of the first component constituent and the inner contour of the recess of the third component constituent are displaced towards one another. The second component constituent is formed with inorganic, non-metallic fibers.

According to a second aspect of the present invention, a hybrid component is described, which hybrid component at least comprises:
a first component constituent made of a metallic first material,
a second component constituent made of an electrically insulating second material, wherein the second component constituent is in the form of a sleeve which encloses the first component constituent with a press-fit, and
a third component constituent made of a metallic third material, wherein the third component constituent has a recess which encloses the second component constituent with a press-fit.

The first component constituent and/or the third component constituent is/are in the form of a sintered component which is formed by sintering a powder blank having metal powder particles arranged adjoining one another. The second component constituent is formed with inorganic, non-metallic fibers.

In brief and without limiting the invention, basic principles concerning the method described herein and the hybrid component which may be produced by the method may be outlined as follows:

It has been recognized that a hybrid component composed of three successive interengaging component constituents may be produced in a simple manner and may be operated reliably even under extreme operating conditions, in particular extreme temperatures, in that at least one so-called sintered component is used in the production thereof. The property of such a sintered component of significantly changing its volume or dimensions on sintering may advantageously be utilized.

For example, the third component constituent, which encloses the first and second component constituents with its recess, may be in the form of a sintered component made from a powder blank. The powder blank may be composed of metal powder particles and may be configured such that it shrinks considerably on sintering at a very high temperature. A degree of shrinkage which thereby occurs may be considerably greater than would be accounted for merely by a coefficient of thermal expansion of the material of the metal powder particles, so that the volume change that occurs on shrinking is largely maintained even after cooling to below the sintering temperature. Owing to such considerable shrinking, an inwardly directed edge of the recess of the third component constituent may, after sintering, press with considerable forces against the two other component constituents accommodated therein and ensure mechanically stable integration of all three component constituents. In particular, the volume changes of the third component constituent caused by the shrinking on sintering may be so pronounced that, during subsequent operation of the hybrid component within a very wide operating temperature range of, for example, 1000° C. or even more, sufficiently stable integration of all the component constituents continues to be ensured despite the thermally induced dimensional changes in the various component constituents.

It has been recognized that the second component constituent, which is interposed between the other two component constituents and, inter alia, may ensure electrical insulation between those two component constituents, may be exposed, in particular during sintering within the context of the production process, both to considerable thermal loads and to considerable mechanical loads. It has been observed that, although sleeve-like second component constituents which are manufactured, for example, from a monolithic ceramic are able to withstand the thermal loads on their own, they often may not withstand them in combination with the mechanical loads brought about during sintering and/or in combination with the expansions and stresses caused by different coefficients of expansion. In order to suitably modify the mechanical properties of the second component constituent in this respect, it is proposed that it is formed with inorganic, non-metallic fibers, since these materials may tolerate higher elongations at break with low stiffness.

Possible configurations of the production method and of the hybrid component as well as possible advantages associated therewith will be described in greater detail hereinbelow.

In the production method proposed herein, at least three component constituents are provided and then assembled to form a complete component assembly. The first and third component constituents each consist of a metallic material, wherein the metallic first material used for the first component constituent differs from the metallic third material used for the third component constituent in terms of a material composition and/or a microscopic structure. The second component constituent consists of a non-metallic, electrically insulating second material.

All three materials are chosen such that they are able to withstand high operating temperatures up to a maximum operating temperature of typically over 800° C., for example 1100° C., without suffering significant irreversible damage. The metallic first material may additionally be chosen to have a high electrical conductivity, such that the first component constituent may serve as an electrode with good electrical conductivity for conducting high electric currents. The electrically insulating second material may be chosen to have a low electrical conductivity, such that the second component constituent is capable of reliably electrically insulating the first component constituent with respect to the third component constituent. The metallic third material may be chosen such that the third component constituent has a high mechanical load-bearing capacity and may serve, for example, for mechanically fixing the hybrid component as a whole to a retaining structure.

The three component constituents are so configured in respect of their geometry that the internal first component constituent may be accommodated in the inner volume of the sleeve-like second component constituent, and the second component constituent may in turn be introduced into the recess in the third component constituent so as to form the complete component assembly as a whole.

The first component constituent may be in the form of a solid or porous solid component or in the form of a hollow component that is hollow on the inside. The first component constituent may have, for example, a cylindrical outer contour. The second component constituent, in the form of a sleeve, surrounds an inner volume which is complementary in respect of its inner contour to the outer contour of the first component constituent. A wall thickness of the second component constituent may be suitably chosen to be able to impart desired electrical insulating properties to the second component constituent. For example, the wall thickness may be in the range of from 0.1 mm to 10 mm, preferably in the range of from 0.5 mm to 5 mm. The third component constituent has a recess, preferably a through-recess, the inner contour of which is complementary to the outer contour of the second component constituent. An outer contour of the third component constituent may be adapted to its intended use and may correspond in respect of its geometric form to the inner contour of that component constituent or may be different therefrom.

“Complementary” may here be understood as meaning that two contours have substantially identical or similar geometric forms, that is to say the cross-sections of both component constituents are, for example, circular, quadrangular, polygonal or the like. The two contours, that is to say the contour of the internal component constituent and the contour of the external component constituent surrounding it, may have identical, similar or slightly different dimensions. In particular, the dimensions of the external contour may be slightly larger than those of the internal contour, so that a small gap which is as constant as possible along the contour circumference remains between the two contours.

Owing to the mutually complementary contours of the three component constituents, the component constituents may then be assembled to form the complete component assembly. To that end, the first component constituent may be inserted into the inner volume of the second component constituent. Previously, at the same time or subsequently, the second component constituent may be inserted into the recess of the third component constituent.

The three component constituents may initially be produced or provided as separate parts and may be assembled only subsequently, but before the sintering operation. During such assembly, at most low forces are exerted on the component constituents, in particular lower forces than is the case in conventional pressing-in. In particular, the first component constituent may be inserted into the inner volume of the second component constituent and the second component constituent may be inserted into the recess of the third component constituent loosely, that is to say with lateral play. The third component constituent may surround the second component constituent accommodated therein in the region of the recess, and the second component constituent may in turn enclose the first component constituent accommodated therein, on all sides, annularly or at least from opposite sides.

The complete component assembly is subsequently sintered by heating to a sintering temperature. The sintering temperature may be so high that considerable diffusion processes and/or at least local melting may occur in particular in the metallic first and/or third material. For example, the sintering temperature may be above 1000° C., preferably above 1100° C. or even above 1200° C. In particular, the sintering temperature may be higher than a maximum operating temperature up to which the hybrid component to be manufactured is to be able to be operated when used as intended.

It comes to bear in the sintering operation that the first component constituent and/or the third component constituent is/are provided in the form of a so-called powder blank.

In this context, a powder blank may be understood as being a blank which is composed of metal powder particles. The metal powder particles may also be referred to as metal particles. The metal powder particles may have microscopically small dimensions, for example in the range of from several nanometers to several hundred micrometers, preferably in the range of from approximately 100 nm to approximately 250 m. The metal powder particles are arranged closely adjoining one another. In particular, the metal powder particles are preferably in close contact with one another. In other words, each metal powder particle contacts one or more adjacent metal powder particles with its outer surface or is arranged at least so closely adjacent relative to such adjacent metal powder particles that a distance between adjacent metal powder particles is negligibly small compared to dimensions of the metal powder particles themselves. For example, a possible distance between adjacent metal powder particles may be less than 30% or even less than 10% of the average dimensions of the metal powder particles. If adjacent metal powder particles are not in direct contact with one another, a gap between adjacent metal powder particles may be filled with different, preferably solid material, such as, for example, a binder. There is generally a force-based connection and/or in some cases a positive connection between the adjacent metal powder particles. Most of the metal powder particles in the powder blank are, however, not connected to adjacent metal powder particles by a material-bonded connection. Owing to the structure of a plurality of small metal powder particles, transitions or particle boundaries form between adjacent metal powder particles. In addition, the metal powder particles may have a widest variety of geometric forms. Accordingly, voids may form between adjacent metal powder particles, in which there is not metal but another material such as, for example, air or binder material. In other words, the powder blank may have a certain porosity, or a large number of small volumes which consist of a material other than the metallic material.

During sintering, partial liquefaction of metal powder particles in the powder blank of the first component constituent and/or diffusion between adjacent metal powder particles in that powder blank may occur. As a result, the powder blank as a whole may change its structure, in particular its microscopic structure or granular structure. For example, adjacent metal powder particles may enter into a material-bonded connection with one another at least in some regions. Boundaries between adjacent metal powder particles may shift and/or dissolve at least in some regions. Voids between adjacent metal powder particles may change in terms of their shape and/or volume. In particular, the powder blank, as a result of the sintering, may form a diffusion structure formed of metal particles connected together by material bonding.

Overall, the powder blank, as is explained in greater detail below, may change its volume or its geometric dimensions, that is to say may shrink or expand, during sintering. As a result, a close force-based connection and/or positive connection may be established between the component constituents. Accordingly, the component constituents may be fixed relative to one another, and the component assembly which was loosely assembled prior to sintering may thus be consolidated to form a mechanically stable hybrid component that acts as a unit.

The enclosed element should have sufficient compressive strength and a suitable coefficient of expansion, so that the enclosed element is not destroyed or does not contract too greatly on cooling.

According to one embodiment, inside dimensions of the recess of the third component constituent are larger prior to sintering than outside dimensions, measured along the same axes, of the second component constituent arranged in the recess, and/or inside dimensions in the inner volume of the second component constituent are larger prior to sintering than outside dimensions, measured along the same axes, of the first component constituent arranged in the inner volume.

The powder blank which forms the third component constituent is configured such that, during sintering, it experiences the volume change that remains even after cooling to below the sintering temperature as shrinkage. Alternatively or in addition, the powder blank which forms the first component constituent is configured such that, during sintering, it experiences the volume change that remains even after cooling to below the sintering temperature as expansion. A geometry of the powder blank of the third and/or first component constituent, properties of the metal powder particles of the respective powder blank and process parameters during sintering are chosen such that the powder blank of the third component constituent shrinks to such an extent on sintering and/or the powder blank of the first component constituent expands to such an extent on sintering that a press-fit occurs in succession between the first, the second and the third component constituents.

In other words, in particular in a direction that runs transverse to a direction in which the component constituent in question is inserted into the inner volume or into the recess of the component constituent surrounding it, the dimensions of the internal component constituent may initially be smaller than those of the inner volume or of the recess. The internal component constituent may thus be introduced into the external component constituent with a certain lateral play or free space.

During the subsequent sintering, use may then be made of the fact that the powder blank of the third component constituent shrinks considerably during sintering and/or that the powder blank of the first component constituent expands considerably during sintering. To that end, a geometry of the powder blank of the first and/or third component constituent, properties of the metal powder particles of the powder blank and process parameters during sintering may purposively be chosen such that the respective powder blank expands or shrinks during sintering to such an extent that a press-fit between the component constituents results. In particular, the powder blank of the third component constituent may shrink so greatly as a result of the sintering that the dimensions of the recess in the third component constituent would shrink on sintering, without the second component constituent being introduced into the recess, to dimensions which would be smaller than the dimensions, measured along the same axes, of the second component constituent being introduced into the recess, so that, with the second component constituent inserted into the recess, sintering produces a force-based press-fit between inner surfaces of the third component constituent in the region of the recess and opposite outer surfaces of the second component constituent.

Alternatively or in addition, the powder blank of the first component constituent may expand so greatly as a result of the sintering that the outside dimensions of the first component constituent, if it were not inserted into the sleeve-like second component constituent, would expand on sintering to dimensions which would be larger than the inside dimensions, measured along the same axes, of the second component constituent enclosing the first component constituent, so that, with the first component constituent inserted into the inner volume of the second component constituent, sintering produces a force-based press-fit between inner surfaces of the second component constituent and opposite outer surfaces of the first component constituent.

In other words, the powder blank and the sintering operation may purposively be adapted such that the powder blank shrinks during sintering onto the second component constituent accommodated in the recess in the powder blank and thereby produces a press-fit. Shrinkage during the sintering operation may be, for example, in a range of from 3% to 30%, typically between 10% and 20%.

A large number of different influencing parameters may affect the degree of shrinkage and thus the press-fit that is produced.

For example, a geometry of the powder blank for the third component constituent, and in particular dimensions of the recess thereof, may be such that, prior to sintering, there is space in the recess for the second component constituent with lateral play, but on sintering, as a result of the associated shrinkage, the dimensions of the recess become smaller, that is to say the lateral play is substantially compensated for by the shrinkage, so that the second component constituent is press-fitted in the recess.

The type, size and/or structure of the metal powder particles as well as the arrangement thereof relative to one another in the powder blank may also influence the extent to which the powder blank shrinks on sintering. For example, the mentioned parameters may influence the way in which geometries and/or grain boundaries between adjacent metal powder particles change during the sintering operation. In particular, these parameters may have an impact on the microscopic structure of the powder blank prior to sintering and possibly also after sintering.

It has been found to be advantageous if a total volume of all the metal powder particles in the powder blank of the first or third component constituent prior to sintering is less than 90%, preferably less than 85%, less than 80% or even less than 75%, of the volume of the first component constituent.

In other words, the total volume of all the metal powder particles may be less than or equal to a volume of all the microscopic volume regions between adjacent metal powder particles. Such microscopic volume regions may also be interpreted as the void volume, wherein the volume regions are not empty but are filled with gas, in particular air, or with a material other than the metallic material of the first or third component constituent, such as, for example, a binder.

A relatively small ratio of the total volume of all the metal powder particles to the volume of the first or third component constituent prior to sintering typically has the result that the powder blank shrinks considerably during sintering and thus a desired press-fit with the second component constituent may be produced.

Alternatively, in particular the first internal component constituent may be configured such that the powder blank thereof does not shrink as a result of a sintering operation but expands in the form of a volume increase. For example, the powder blank may to that end contain both iron particles and copper particles.

During sintering, diffusion processes between the iron particles and the copper particles may then occur, wherein a resulting mixture or alloy has a lower density than in the case of the pure iron and copper particles, so that a volume increase occurs. Typical materials are, for example, FeCu1.2, FeCu5, FeCu10 and FeCu20, optionally with additional additives.

The behavior of component constituents during sintering is generally highly dependent upon their material composition. For example, the metallic material of the first and/or third component constituent may contain at least one metal selected from the group comprising iron (Fe), copper (Cu), molybdenum (Mo), nickel (Ni), chromium (Cr), titanium (Ti), cobalt (Co) and tin (Sn).

The mentioned metals may be contained in the metallic material as a main constituent or as an additive. In particular, the metallic material may be an alloy or mixture which contains one or more of the mentioned metals. For example, the metallic material may be brass. Brass is understood as being a copper alloy with up to 40% zinc. Alternatively, the metallic material may be a bronze. Bronzes denote alloys with at least 60% copper, provided that they are not to be allocated to the brasses owing to the main alloying additive zinc.

According to one embodiment, the powder blank of the first or third component constituent may be manufactured by means of metal injection molding.

Metal injection molding, also referred to as the MIM process, is a primary shaping process for the production of metallic components of complex geometry. It has similarities with the injection molding technology used in the processing of plastics materials. In metal injection molding, fine metal powder is generally mixed with an organic binder and then shaped with the aid of an injection molding machine. The intermediate product thereby formed is mostly referred to as a green part. In the green part, the metal powder particles may adjoin one another, and the binder may provide an additional force-based connection between adjacent metal powder particles. The binder is then removed to produce a brown part, and the component so formed is sintered at high temperature in a furnace. As a result, a purely metallic end product is generally obtained, which combines the mechanical advantages of sintered components with the wide variety of shapes which are possible with injection molding.

Metal injection molding has a large number of advantages. Inter alia, components with complex geometry may be manufactured with the aid of metal injection molding. Production costs may remain relatively low. In particular, reproducibility may be achieved even in very large piece numbers. Components may be produced ready for installation and in all refinement stages at low unit costs. Owing to high material and energy efficiency, components may be produced in an environmentally friendly and resource-efficient manner.

Streamlined, stable processes (LeanSigma) may be used, and narrow tolerances may be observed even in the case of complex geometries. A weight saving compared to parts produced by other methods and ultimately also recyclability may also be advantageous.

According to an alternative embodiment, the powder blank of the first or third component constituent may be manufactured by pressing metal powder into a predefined shape.

A technique that is used here is also referred to as the axial pressing technique. In this technique, a raw powder of small metal powder particles is processed.

Different raw powders may optionally be mixed together. By means of mechanical, hydraulic and/or electric presses, the raw powder may be pressed in shaping tools to form manageable component constituents, which at this stage of the process are again referred to as powder blanks. The presses may typically exert forces in the range of from 30 kN up to 8000 kN. Adjacent metal powder particles may thereby be pressed into flat contact with one another and are then held together by force-based engagement.

A shrinkage behavior, which occurs during sintering, of powder blanks which have been produced by pressing metal powder may be influenced, inter alia, by properties of the raw powder used or of a mixture of different raw powders, but also by the manner in which the powder is pressed.

The manufacture of component constituents with the aid of the axial pressing technique may permit many of the advantages already explained above for metal injection molding. However, compared to metal injection molding, the manufacture of powder blanks by pressing metal powder is in most cases less expensive. However, component constituents with simple geometries may primarily be manufactured.

According to a further alternative embodiment, the powder blank may be manufactured by additive manufacture by the successive application of multiple layers of a compound containing metal powder.

Additive manufacture, which is sometimes also referred to as 3D printing, is understood as meaning manufacturing methods in which material is applied layer by layer in order to produce three-dimensional objects. Metal powder particles, loose or incorporated in a matrix material, may be applied in succession layer by layer to a carrier substrate or to previously formed parts of a product to be formed, and then consolidated. For example, in the so-called SLS (selective laser sintering) process, metal powder particles may be applied in layers and then sintered together or melted only in desired regions with the aid of a laser, wherein particles in regions that have not been lasered may subsequently be removed again. With the aid of additive manufacture, it is thus possible to form powder blanks which have similar properties and/or may be produced with similar advantages to those described above for the metal injection molding or pressing of powder blanks.

As a result of the shrinkage or expansion, which occurs on sintering, of the powder blank acting as the third or first component constituent, considerable forces are exerted on the sleeve-like second component constituent interposed between the first and third component constituents. It has been recognized that, in order to achieve a desired press-fit between the three component constituents, the second component constituent should advantageously have an at least slightly damage-free deformability.

In particular, according to one embodiment, the second material, that is to say the material of the second component constituent, should have an elongation at break of at least 0.1%, preferably at least 0.2%.

Owing to such a substantial elongation at break, the second component constituent is able to deform radially inwards under the shrinkage forces acting thereon during sintering or, alternatively, is able to deform radially outwards under the expansion forces acting thereon during sintering. In other words, the second component constituent, when it is pressed radially inwards by the third component constituent surrounding it during the sintering-related shrinking process thereof, may yield at least slightly to this pressure and deform towards the internal first component constituent. In this manner, a press-fit both between the third and the second component constituents and between the second and the first component constituents may be achieved overall. Alternatively, the second component constituent, when it is pressed radially outwards by the first component constituent that it surrounds during the sintering-related expansion process thereof, may yield at least slightly to this pressure and deform towards the third component constituent surrounding it. In this case too, a press-fit between all three component constituents may again be achieved overall.

It has been observed that monolithic ceramic components, for example, which are in the form of sleeves and, similarly to the second component constituent described herein, are subjected to considerable forces by an internal or an external further component constituent on expansion or shrinkage thereof, are generally not able to withstand these forces. This is attributed, inter alia, to the fact that, although such monolithic ceramic components have a high strength, they possess only a very low elongation at break, so that, when specific force limits are exceeded, the ceramic sleeve does not deform but instead breaks.

It is therefore proposed, in the production method described herein, to purposively form the second component constituent with inorganic, non-metallic fibers, wherein these fibers may contribute towards increasing an elongation at break of the second material used for this component constituent to a desired extent. The second material may accordingly also be referred to as fiber-reinforced or fiber-based.

In particular, according to one embodiment, the second component constituent may be formed with ceramic fibers and/or basalt as well as glass fibers.

Ceramic fibers consist of an inorganic, non-metallic material and are typically polycrystalline or amorphous. For example, ceramic fibers may be produced from a polymeric precursor by pyrolysis. Important non-oxide fibers are based on SiC, SiCN, SiBNC or carbon (C). The ceramic fibers may be in the form of oxide fibers and may be produced, for example, by dry spinning processes, in particular based on aluminum (Al), that is to say, for example, as aluminum oxide, or based on aluminum and silicon, that is to say, for example, as mullite. In addition, further substances such as iron (Fe), magnesium (Mg), calcium (Ca), titanium (Ti), zirconium (Zr), yttrium (Y), boron (B) or the oxides thereof may be added.

Such fibers are generally polycrystalline. Alternatively, the ceramic fibers may be in the form of non-oxide fibers, for example in the form of silicon carbide fibers.

Ceramic fibers may have a very high tensile strength and extensibility. In addition, ceramic fibers are able to withstand very high temperatures up to, for example, 1100° C., 1200° C. or even more without being damaged.

Glass fibers or basalt fibers are generally produced by drawing from a melt. They are generally amorphous. They may have similar mechanical and temperature-resistant properties to ceramic fibers.

The ceramic fibers or glass fibers used to form the second component constituent may have a very small thickness, for example in a range of from 5 m to 500 m, preferably from 10 m to 20 m. The fibers may in particular be in the form of long fibers and may be combined to form rovings (fiber bundles) comprising up to 50 k individual filaments. The fiber rovings may preferably be arranged such that they form a woven fabric, a non-crimped fabric, a nonwoven or the like. The fibers may form a layer. This layer may form, for example, a wall of the sleeve-like second component constituent. Within the layer, the fibers may be provided in a sufficient density to give the second component constituent a desired mechanical loading-bearing ability. In addition, the fibers may be provided in a sufficient layer thickness, density and orientation relative to one another, so that the second component constituent formed therewith is compressed, even in the case of pronounced radial compressive stress, only to such an extent that the wall of the component constituent is still sufficiently thick to ensure a desired electrical insulation between adjoining other component constituents. For example, such a wall should be between 0.1 mm and 10 mm, preferably between 0.3 mm and 3 mm, thick, depending upon the application.

The sleeve-like second component constituent may consist only of the ceramic fibers or glass fibers. For example, the fibers may be braided, woven, spun or laid to form a type of tube.

According to one embodiment, the second component constituent may be formed with an oxide ceramic composite.

Oxide ceramic composites are in some cases also referred to as OFC materials (oxide fiber ceramics) or OCMC materials (oxide ceramic matrix composites). In such materials, oxide ceramic fibers are embedded in an oxide ceramic matrix.

They have similar advantageous properties to monolithic ceramics, for example high temperature resistance, corrosion resistance, high strength. The modulus of elasticity is lower compared to monolithic ceramics, whereas the elongation at break is significantly higher. Unlike monolithic ceramics, they additionally do not exhibit brittle fracture behavior, but instead exhibit a damage-tolerant, quasi-ductile fracture behavior. This quasi-ductile fracture behavior occurs in particular as a result of energy-dissipating effects, that is to say as a result of a typically weak attachment between the fibers and the surrounding porous matrix, whereby cracks or fractures, for example, are not introduced directly from the matrix into the fibers but are diverted or branched parallel thereto or lose energy through microcrack formation. The incorporated fibers serve predominantly to increase the fracture toughness compared to a dense, monolithic ceramic. Therefore, such composites, unlike monolithic ceramics, have excellent thermal shock resistance.

The oxide ceramic composite may further have, for example, a modulus of elasticity of less than 100 GPa and may achieve elongations at break of over 0.4%. The coefficient of thermal expansion is dependent above all upon the fibers used and generally corresponds to the monolithic variant. In the case of fibers based on aluminum oxide or mullite, the coefficient of thermal expansion is in most cases in the range of from 4 to 10 ppm/K.

The shaping of the oxide ceramic composites may take place starting from sheet-form fabric-reinforced or short-fiber-reinforced oxide ceramic prepregs, which are densified by means of an autoclave process. However, in the case of the production of rotationally symmetrical tubular parts, fiber-coiling processes, in which matrix-impregnated roving strands are deposited on a rotating core, are suitable. The fiber architecture should be so chosen that deformation is facilitated and loads may be absorbed without damage. The production of OFCs is generally completed by a sintering process at temperatures above 1000° C. In order to obtain the final geometry of the second component constituent, mechanical machining by sawing, milling, laser cutting or water-jet cutting may be necessary.

According to one embodiment, the first material has a coefficient of expansion α₁, the second material has a coefficient of expansion α₂ and the third material has a coefficient of expansion α₃, and α₂<α₁<α₃.

In other words, it has been found that a special selection of the materials used for each of the three component constituents in respect of their coefficients of thermal expansion may result in advantageous properties of the hybrid component produced therewith, or that the disadvantage of the low coefficient of expansion of the ceramic component may be overcome. In addition, the coefficient of thermal expansion α₁ of the first material for the internal first component constituent should preferably be lower than the coefficient of thermal expansion as of the third material for the external third component constituent.

As will be described below with reference to a concrete example of the production method according to the invention, the special choice of the coefficient of thermal expansion may make it possible to achieve an advantageous expansion behavior of the various component constituents relative to one another during sintering on initial heating and on subsequent cooling.

In particular, according to a concrete embodiment, the coefficient of thermal expansion α₂ may be <12 ppm/K and/or α₃ may be <25 ppm/K. Such a choice of the coefficients of thermal expansion may have a particularly advantageous impact in the production described herein of the hybrid component.

One embodiment of the hybrid component according to the second aspect of the invention may be manufactured with the aid of an embodiment of the production method described above and may thus have the features resulting from the production.

The hybrid component may be configured with its first component constituent and/or its third component constituent as a sintered component. Such a sintered component is obtained by debinding a green part, specifically a component produced by MIM technology, pressing technologies or by additive technologies, and subsequently sintering it. It typically has a diffusion structure formed of metal powder particles connected together by material bonding, in which metal powder particles are connected together by material bonding at least in some regions by sintering. Such a structure may also be referred to as a granular structure. In other words, the metal powder particles in the component constituent formed by the sintered component may at least in some regions be fused with adjacent metal powder particles and/or connected by diffusion processes. Such a structure is typically obtained when a component constituent made of a material which has been composed beforehand from metal powder particles is sintered at high temperatures. The granular structure differs in principle from microscopic structures as are to be observed in conventional component constituents, for example manufactured from solid material.

In addition to the advantage that a hybrid component having the described granular structure may advantageously be produced by the method indicated above, the granular structure may also effect advantageous properties for the hybrid component itself, such as, for example, a high strength with at the same time a comparatively low weight.

According to one embodiment, in the hybrid component, at an interface at which an external surface of the first component constituent adjoins an opposite internal surface of the second component constituent, and/or at an interface at which an external surface of the second component constituent adjoins an opposite internal surface in the recess of the third component constituent, a surface structure formed on the respective external surface may engage into a complementary surface structure on the respective opposite internal surface.

In other words, the hybrid component, optionally as a result of properties of the production method indicated above, may have a special microscopic structure at the interface between its component constituents. This microscopic structure may arise, for example, as a result of the fact that at least one or preferably both of the component constituents does/do not need to be specially machined prior to the sintering in order to smooth the surface thereof. Accordingly, the surface of the respective component constituents may have an at least microscopic roughness where they adjoin one another. Alternatively or in addition, the surfaces of the two component constituents may purposively be formed with a mutually complementary surface structure, for example in the form of a micro-serration.

Microscopic projections and/or depressions, as are formed by the respective surface structures, may press into the respective other component constituent during the shrinkage or expansion process caused by the sintering and thereby lead to an interengagement or micro-serration between the opposite surfaces of the two component constituents. The dimensions of the surface structure may typically be between several tenths of a micrometer and several 10 m.

While microscopic structures on surfaces of component constituents to be connected together have in most cases been removed beforehand in conventional production methods by suitable machining or have been smoothed (in particular sheared off or broken off) at the latest during joining, for example in the context of pressing-in or thermal shrinking, such microscopic structures may often survive the sintering-related shrinking substantially unchanged in the production method described herein. Accordingly, the resulting complementary engagement between mutually adjoining surface structures, or the resulting micro-serration, may occur as a typical feature in the hybrid components produced by the described production method. The engagement or the micro-serration may further ensure a particularly efficient hold between the two component constituents.

It is pointed out that possible features and advantages of embodiments of the invention are described herein partly in relation to a production method configured according to the invention and partly in relation to a hybrid component configured according to the invention. A person skilled in the art will recognize that the features described for individual embodiments may in an analogous manner be suitably transferred to other embodiments, may be adapted and/or interchanged in order to arrive at further embodiments of the invention and possibly synergistic effects.

### BRIEF DESCRIPTION OF THE DRAWINGS

Advantageous embodiments of the invention will be explained further hereinbelow with reference to the accompanying drawings, wherein neither the drawings nor the explanations are to be interpreted as limiting the invention in any way.

FIG. 1 is a sectional view through a hybrid component in the form of an electrode according to an embodiment of the present invention.

FIG. 2 illustrates, in cross-sectional views, a sequence of method stages during a production method according to an embodiment of the present invention.

The figures are merely schematic and not true to scale. In the various drawings, the same reference numerals denote features which are the same or have the same effect.

### DETAILED DESCRIPTION

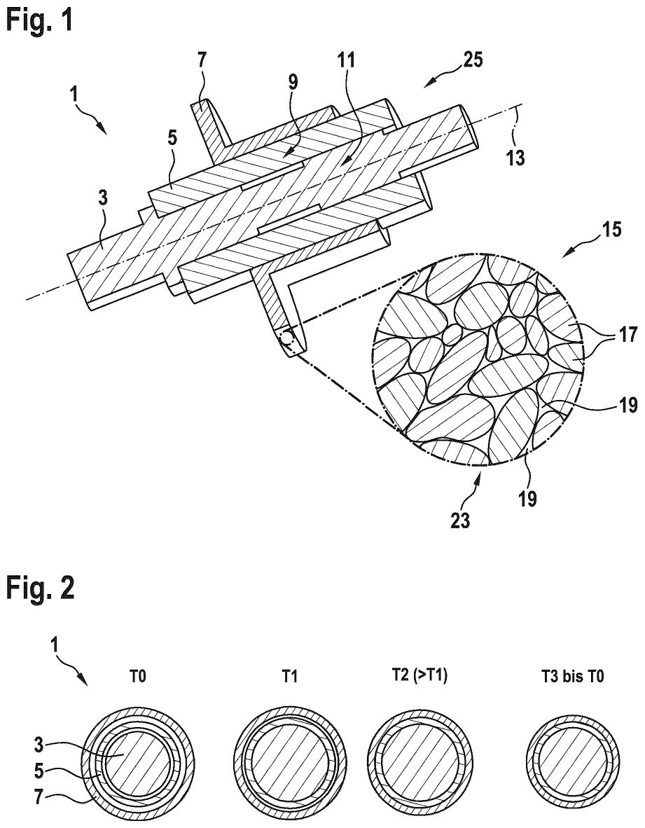

FIG. 1 shows an example of a hybrid component 1 in the form of an electrode for a catalyst converter preheater in a motor vehicle.

The hybrid component 1 is composed of an internal first component constituent 3 in the form of a core, an external third component constituent 7 in the form of a holder, and a sleeve-like second component constituent 5 interposed between the first and third component constituents 3, 7, which serves as an insulating body.

The first and third component constituents 3, 7 consist of a metallic material, whereas the second component constituent 5 consists of a non-metallic, electrically insulating material and in particular is formed with inorganic, non-metallic fibers. The second component constituent 5 is accommodated in a recess 9 of the third component constituent 7 and in turn accommodates the first component constituent 3 in its inner volume 11. All the component constituents 3, 5, 7 are rotationally symmetrical about an axis of rotation 13.

As is shown in the enlarged detail in FIG. 1, the third component constituent 7 in the example shown has a microscopic granular structure 15 with a diffusion structure formed by metal powder particles 17 connected together by material bonding. Metal powder particles 17 adjoin adjacent metal powder particles 17. Since the metal powder particles 17 may have irregular shapes and sizes, voids 19 form between adjacent metal powder particles 17. While the voids 19 may still have comparatively large volumes during an intermediate stage of the production method described below, in which the third component constituent 7 is present as a powder blank 23 in the form of a green part or brown part, in the finished hybrid component 1 they mostly have only a very small volume, or the porous granular structure 15 originally present in the powder blank 23 or the product obtained therefrom by sintering is mainly discernible in the third component constituent 7 of the finished hybrid component 1 by means of particle boundaries that remain. While adjacent metal powder particles 17 in the green part generally cooperate only by force-based engagement and/or positive engagement, adjacent metal powder particles 17 may be connected together by material bonding at least in some regions in the finished hybrid component 1 after a sintering operation.

As a result of the method described in greater detail below, with which the hybrid component 1 has been produced, the first, second and third component constituents 3, 5, 7 are seated coaxially to one another with a press-fit, wherein the component constituents 3, 5, 7 cooperate with one another at an interface by force-based engagement and in some cases optionally also by positive engagement.

In order to produce the hybrid component 1 shown, the first, second and third component constituents 3, 5, 7 are first produced and provided as separate constituents.

In the example shown, the first component constituent 3 is a solid component which consists of a metal with good electrical conductivity and has been cast, for example, or produced from a solid material by material-removing methods such as turning. The first component constituent 3 has an elongate, cylindrical geometry.

The second component constituent 5 is a ceramic sleeve with a cylindrical wall, the inside diameter of which is slightly larger than an outside diameter of the first component constituent 3. In the example shown, this sleeve is produced from an oxide ceramic composite. Long fibers, in particular ceramic fibers, are embedded in a ceramic material serving as a matrix. The oxide ceramic composite may be produced by a coiling technique. Fibers of aluminum oxide are embedded in a porous matrix of aluminum oxide. Alternatively, the second component constituent 5 could also consist only of fibers, for example ceramic fibers or glass fibers, for example in the form of a braided tube. The material is chosen such that the second component constituent 5 may be elastically deformed by the other components and compressive stresses do not cause any damage. The material should additionally be gas-tight.

The third component constituent 7 is a powder blank 23 in the form of a green part or brown part. In the example shown, this green part or brown part is manufactured by metal injection molding, that is to say by an MIM process. To that end, a powder of metallic particles is first mixed with binder. The mixture is then injection molded into a desired shape. The binder may subsequently be removed and in this way the brown part may be produced.

A complete component assembly 25 is then formed from the three component constituents 3, 5, 7. To that end, the first component constituent 3 is inserted into the inner volume 11 in the sleeve-like second component constituent 5, wherein there is at least a slight play between the two component constituents 3, 5 so that the two component constituents 3, 5 may be pushed together without an application of considerable force. In addition, the second component constituent 5 is inserted into the recess 9 in the third component constituent 7, wherein there is again a lateral play between the two component constituents 5, 7.

The outside diameter of the first component constituent 3 of a nickel-based alloy is, for example, 7.8 mm. The inside diameter of the second component constituent 5 of aluminum oxide fiber-reinforced aluminum oxide is 8 mm with an outside diameter of 10 mm. The aluminum oxide fiber-reinforced aluminum oxide has a thermal expansion in the region of 8 ppm/K and an elongation at break >0.4%.

The modulus is <100 GPa. The inside diameter of the third component constituent 7 consisting of a green part or brown part of stainless steel or nickel-based alloy is 11 mm prior to the heat treatment. The coefficient of thermal expansion of the first component constituent 3 and third component constituent 7 is in the region of 14 ppm/K.

The complete component assembly 25 may then be sintered at, for example, 1200° C. The third component constituent 7, and in particular the recess 9 thereof, thereby shrinks significantly, that is to say, for example, by 10-20%, owing to the granular structure 15 in its metallic material. In particular as a result of this shrinkage and the thermal expansions of component constituents 3, 5, 7, the press-fit between the component constituents 3, 5, 7 is established.

Inter alia by a suitable selection of the materials for the three component constituents 3, 5, 7 in respect of their coefficients of thermal expansion, the sintering process and the press-fit that is ultimately established may be influenced particularly advantageously. The coefficient of expansion α₂ of the second component constituent 5 should be significantly lower than the coefficient of expansion α₁ of the internal first component constituent 3, which in turn should be lower than the coefficient of expansion as of the external third component constituent 7, that is to say α₂<α₁<α₃. The low coefficient of expansion and the limited elongation at break of the second component constituent 5 require all the component geometries to be matched exactly, so as to avoid excessive expansion or compression of the second component constituent 5. In addition, the second component constituent 5 must be able to be deformed by the first component constituent 3 and the third component constituent 7. Therefore, a material with a low modulus and small wall thicknesses should be chosen for the second component constituent 5.

As a result, as is illustrated schematically in FIG. 2, during the sintering process, on initial heating starting from a starting temperature T0 to an elevated first temperature T1>T0, the first component constituent 3 may expand considerably more than the surrounding sleeve-like second component constituent 5, until it first abuts it and subsequently elastically expands it at least slightly. As a result, the first component constituent 3 supports the second component constituent 5 and the gap is closed.

If the temperature is then increased further to a second temperature T2>T1, which corresponds to the sintering temperature at which the green part 21 begins to change its microscopic structure owing to diffusion processes and/or local melting processes, shrinking of the third component constituent 7 formed by the powder blank 23 begins.

The third component constituent 7 thereby changes its volume to an extent that goes significantly beyond the changes which would be attributable merely to thermally related volume changes due to the coefficient of thermal expansion of the third material. In other words, the third component constituent 7 changes its volume during sintering as a result of the shrinking of its originally highly porous structure, such that the volume remains even after subsequent cooling to the starting temperature TO.

Accordingly, the recess 9 in the third component constituent 7, in a temperature range ranging from ambient temperature T0 to the maximum operating temperature T3, which is lower than the sintering temperature T2 (T3<T2), has a significantly smaller inside diameter after sintering than prior to sintering and thus presses the sleeve-like second component constituent 5 against the first component constituent 3 received therein.

During the temperature treatment, the second component constituent 5 is thus first expanded radially outwards on heating and then, on cooling, is compressed radially inwards. However, because it has a significant elongation at break, owing to the fibers it contains, and the maximum expansion may be reduced as a result of the initial expansion, which is limited by the expansion of the first component constituent 3 and the initial gap distance between the first component constituent 3 and the second component constituent 5, and subsequent compression, which is limited by the supporting action of the first component constituent 3, no substantial cracks or fractures occur in the second component constituent 5 during these deformations. At room temperature, tensile tangential stresses are present at the third component constituent 7. Because the second component constituent 5 accordingly remains intact, it may serve as efficient electrical insulation between the first and third component constituents 3, 7 in the finished hybrid component 1.

In the described production method, use is made in particular of the physical effect that the first component constituent 3 manufactured by metal injection molding shrinks on subsequent sintering more than it expands during later use, for example owing to changing temperatures. Inter alia, new possibilities in the field of a force-based connection, a positive connection and/or undercuts are thus possible.

Finally, possible configurations and advantages which may thereby be achieved of a possible preferred embodiment will again be described, in some cases with a slightly different wording.

In one embodiment of the production according to the invention of the composite component, oxide ceramic fiber composite ceramics (aluminum fiber ceramic) are used as the intermediate layer and metal injection molding parts are used for the shell. The ceramic intermediate layer performs an electrical insulating function between the inner and outer metal parts. As a result of the sintering shrinkage >10% of the nominal dimension in the course of processing, the outer MIM component is flowed round onto the fiber ceramic by sintering and is shrunk onto it by further cooling, specifically to a greater extent than by a pure thermal joining process. The fiber ceramic with high elongation at break absorbs the compressive stresses, and the joint seat with the inner metal component becomes more intimate and dense.

The application is to be seen, inter alia, in electrodes for current feedthrough with good separation of the reaction spaces. By selecting suitable metallic materials, areas of application of over 1000° C. may be achieved and thermal shock requirements are in principle fulfilled.

Hitherto, similar electrodes have mostly been manufactured using the following technologies:
a) use of thermal joining of ceramic-coated metal core and outer metallic sleeve;
b) stamping of ceramic compounds into the intermediate zone between an outer metallic shell and an inner metallic core;
c) polymers as electrically insulating intermediate layers.

However, the following disadvantages, inter alia, have been observed:
difficult ambient conditions (atmosphere, humidity) and high temperatures lead to ageing effects, settling of compounds;
monolithic ceramics fail under thermal shock or because of the thermal expansion of the metals or as a result of the low elongation at break or mechanical load due to vibrations;
small layer thickness of the ceramic layer does not meet the requirements in respect of electrical insulation;
purely thermal joining requires a large temperature or CTE difference between metals and good dimensional stability of the parts to be joined;
geometric limitations, for example in the case of the internal metallic core or shell;

With the aid of embodiments of the solution presented herein, the following advantages, inter alia, are strived for:
electrode feedthrough for high temperatures and under thermal shock conditions with the tight separation of reaction spaces, for example for electrical catalytic converter preheating require such contacting elements;
electrically insulating shaft/hub connections for the most extreme application conditions without settling effects;
replacement of electrically insulating insulation components of metal and monolithic ceramic, which may be joined by welding.

Embodiments may in particular be configured as sinter shrinkage methods for the production of a multi-part multi-material composite body/composite which is advantageously composed of constituents as follows:
i) internal metallic core with a coefficient of thermal expansion α1,
ii) ceramic sleeve intermediate layer with a coefficient of thermal expansion α2,
iii) external sintered metallic shell with a coefficient of thermal expansion α3, wherein α2<α1<α3.

The heat treatment after assembly of all the constituents of the composite body includes sintering of the sintered metal and is composed of three temperature stages T0<T1<T3<T2:
i) expansion of the metallic core until it abuts the ceramic intermediate layer, and elastic expansion of the ceramic intermediate layer by the internal metal core on heating from T0 to T1 owing to the higher thermal expansion of the metallic core αS compared to the ceramic sleeve α2;
ii) initial shrinkage of the external metallic sintered body by sintering until it abuts the expanded ceramic sleeve on further heating from T1 to T2;
iii) consolidation and thermal contraction of the outer sintered metal shell by cooling from T3 to T0 and accompanying pressing of the ceramic sleeve against the internal metallic core, the coefficient of thermal expansion αS of which is lower than that of the sintered metal shell.

The sintered metal may contain at least one element from the group Ni, Cr, Fe, . . . and may have a coefficient of thermal expansion in the region of less than 25 ppm/K and a modulus of less than <220 GPa.

The ceramic sleeve may be made of an oxide ceramic composite which contains, for example, at least one element from the group Al, Zr, Y, Si, . . . . The oxide ceramic composite may have an elongation at break of greater than 0.1%, preferably greater than 0.2%, and a coefficient of thermal expansion in the region of less than 12 ppm/K and a modulus of less than <100 GPa and may be electrically insulating.

The heat treatment step T2 may take place at temperatures above 1200° C. in a non-oxidizing atmosphere and T3<1100° C. may constitute the maximum use temperature. All constituents in each case have the same temperature.

The internal metallic core may have a high temperature-independent electrical conductivity up to 1000° C.

The composite body may be an electrode or an electrically insulating shaft/hub connection.

Finally, it should be pointed out that terms such as “having”, “comprising”, etc. do not exclude any other elements or steps, and terms such as “a” or “one” do not exclude a multiple. It should further be pointed out that features or steps which have been described with reference to one of the above exemplary embodiments may also be used in combination with other features or steps of other exemplary embodiments described above. Reference numerals in the claims are not to be regarded as limiting.

### LIST OF REFERENCE NUMERALS

1 hybrid component
3 first component constituent
5 second component constituent
7 third component constituent
9 recess
11 inner volume
13 axis of rotation
15 granular structure
17 metal powder particles
19 voids
23 powder blank
25 complete component assembly

1. A method for producing a hybrid component, comprising:
providing a first component constituent made of a metallic first material,
providing a second component constituent made of an electrically insulating second material, wherein the second component constituent is in the form of a sleeve which surrounds an inner volume which has an inner contour complementary to an outer contour of the first component constituent,
providing a third component constituent made of a metallic third material, wherein the third component constituent has a recess which has an inner contour complementary to an outer contour of the second component constituent,
forming a complete component assembly by arranging the first component constituent in the inner volume of the second component constituent and arranging the second component constituent in the recess of the third component constituent,
sintering the complete component assembly by heating to a sintering temperature, wherein the first component constituent and/or the third component constituent is/are in the form of a powder blank having metal powder particles arranged adjoining one another, such that, when the sintering temperature is reached, the metal powder particles are sintered together and the component constituent in question thereby experiences a volume change that remains even after cooling to below the sintering temperature in such a manner that the outer contour of the first component constituent and the inner contour of the recess of the third component constituent are displaced towards one another,
wherein the second component constituent is formed with inorganic, non-metallic fibers.

2. The method as claimed in claim 1,
wherein inside dimensions of the recess of the third component constituent are larger prior to sintering than outside dimensions, measured along the same axes, of the second component constituent arranged in the recess, and/or wherein inside dimensions in the inner volume of the second component constituent are larger prior to sintering than outside dimensions, measured along the same axes, of the first component constituent arranged in the inner volume of the second component constituent,
wherein the powder blank which forms the third component constituent, during sintering, experiences the volume change that remains even after cooling to below the sintering temperature as shrinkage, and/or wherein the powder blank which forms the first component constituent, during sintering, experiences the volume change that remains even after cooling to below the sintering temperature as expansion,
wherein a geometry of the powder blank of the third and/or first component constituent, properties of the metal powder particles of the respective powder blank and process parameters during sintering are chosen such that the powder blank of the third component constituent shrinks to such an extent on sintering and/or the powder blank of the first component constituent expands to such an extent on sintering that a press-fit occurs between the first, the second and the third component constituents.

3. The method as claimed in claim 1,
wherein the powder blank is manufactured by means of metal injection molding.

4. The method as claimed in claim 1,
wherein the powder blank is manufactured by pressing metal powder into a predefined shape.

5. The method as claimed in claim 1,
wherein the powder blank is manufactured by additive manufacture by successive application of multiple layers of a compound containing metal powder.

6. The method as claimed in claim 1,
wherein a total volume of all the metal powder particles in the powder blank prior to the sintering is less than 90% of the volume of the powder blank.

7. The method as claimed in claim 1,
wherein the sintering temperature is higher than a maximum operating temperature up to which the hybrid component is able to be operated when used as intended.

8. The method as claimed in claim 1,
wherein the second material has an elongation at break of at least 0.1%.

9. The method as claimed in claim 1,
wherein the second component constituent is formed with ceramic fibers, basalt fibers and/or glass fibers.

10. The method as claimed in claim 1,
wherein the second component constituent is formed with an oxide ceramic composite.

11. The method as claimed in claim 1,
wherein the first material has a coefficient of thermal expansion α₁, the second material has a coefficient of thermal expansion α₂ and the third material has a coefficient of thermal expansion α₃,
wherein α₂<α₁<₃.

12. The method as claimed in claim 11,
wherein α₂<12 ppm/K and/or wherein α₃<25 ppm/K.

13. A hybrid component, having:
a first component constituent made of a metallic first material,
a second component constituent made of an electrically insulating second material, wherein the second component constituent is in the form of a sleeve which encloses the first component constituent with a press-fit,
a third component constituent made of a metallic third material, wherein the third component constituent has a recess which encloses the second component constituent with a press-fit,
wherein the first component constituent and/or the third component constituent is/are in the form of a sintered component which is formed by sintering a powder blank having metal powder particles arranged adjoining one another, wherein the second component constituent is formed with inorganic, non-metallic fibers.

14. The hybrid component as claimed in claim 13,
wherein the sintered component has a diffusion structure formed of metal powder particles connected to one another by material bonding.

15. The hybrid component as claimed in claim 13,
wherein, at an interface at which an external surface of the first component constituent adjoins an opposite internal surface of the second component constituent, and/or at an interface at which an external surface of the second component constituent adjoins an opposite internal surface in the recess of the third component constituent, a surface structure formed on the respective external surface engages into a complementary surface structure on the respective opposite internal surface.
